(19) United States
(12) Patent Application Publication
(10) Pub. No.: US 2004/0098298 A1
(43) Pub. Date: May 20, 2004

(54) Monitoring responses to visual stimuli

(76) Inventor: Jia Hong Yin, London (GB)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/616,706

(22) Filed: Jul. 10, 2003

Related U.S. Application Data
(63) Continuation of application No. PCT/GB02/00247, filed on Jan. 22, 2002.

(30) Foreign Application Priority Data
Jan. 24, 2001 (GB) 0101794.6

(51) Int. Cl. G06F 17/60

(52) U.S. Cl. 705/10

(57) ABSTRACT

A monitoring system including a video viewer sited to view an area of interest characterized by its proximity to, and/or location with respect to, at least one visual stimulus, a generator of electrical signals representing video images of the area at different times, processor for processing the signals to determine a behavior pattern of people traversing said area and a response indicator utilizing the behavior pattern to provide an indication of a response by said people to said visual stimulus.

### RELATED APPLICATIONS

This application is a continuation of International Application PCT/GB02/00247 filed Jan. 22, 2002, the contents of which are here incorporated by reference in their entirety.

### BACKGROUND OF THE INVENTION

1. Field of the Invention

This invention is concerned with monitoring responses to visual stimuli, and especially, though not exclusively, with monitoring the reaction of people to displays of goods in stores.

2. Prior Art

Monitoring the response of people to certain visual stimuli, such as arrays of goods displayed for purchase in stores, has much potential value, and many potential uses.

Store managers, for example, can discern (amongst other things) the whereabouts of prime selling locations in their stores, how popular certain products are, and whether

displays that are effective in creating interest in some goods actually create problems in relation to other goods, for example directly, by reducing access to them, or indirectly, by causing localized obstructions which deter other shoppers from entering the affected area.

If the information as to response is supplemental with information indicative of direct interaction between customers and the goods displayed, it is further possible, by comparing information indicating when goods have been removed from a display into an active a ales inventory system coupled to point of sale scanners, to determine whether goods so removed are paid for at a point of sale.

It is also of significant value to monitor several sites within a store, or the full coverage of a store, and to correlate the information from the various sites to provide “global” information about customer activity within the store as a whole. This enables so-called “loot-spots” and “cool-spots”, namely in-store locations at which levels of customer interest are relatively high and relatively low, respectively.

The global information can be derived automatically by suitable processing of the data derived from the various in-store locations monitored, and presented in any convenient manner to assist suppliers of product, for example, to assimilate information such as the effectiveness of various stores in promoting their goods, and to identify the sites, within stores, at which their products are displayed to best effect. The information can, of course, also reveal whether their products are indeed being displayed in prime in-store locations (hot-spots) that have been paid for.

Ultimately, such information can assist manufacturers and suppliers to better understand Customer response to their products, foresee future trends and develop new products.

Much information of the requisite kind could, of course, be gathered manually by employing observers to directly monitor and note what is going on, but such activity is fraught with difficulties.

Apart from the fact that, by and large, people do not like being watched, and thus that any attempt to introduce observers into the close proximity of goods on display would likely be counter-productive by driving customers away from the store, the degree of attention that needs to be continuously applied to the task and the rather tedious

nature of the work and the subjective judgments that need to be made as to classifying degrees of interest militate against the effectiveness of such arrangements and tend to

make direct observation an unreliable source of data. Similar comments apply to the manual analysis of pre-recorded video footage.

### SUMMARY OF THE INVENTION

An object of this invention is to provide a system that is capable of automatically processing information about the response of people to visual stimuli, thereby to reliably

produce meaningful data concerning such response. A further object is to provide such data in a manner that can be readily assimilated and interpreted by system users or by others commissioning or sponsoring the system's use.

According to this invention from one aspect, therefore, there is provided a monitoring system comprising video means sited to view an area of interest characterized by its proximity to, and/or location with respect to, at least one visual stimulus, means for generating electrical signals representing video images of said area at different times, processing means for processing said signals to determine a behavior pattern of people traversing said area and means utilizing said behavior pattern to provide an indication of a response by said people to said visual stimulus The invention thus permits behavior patterns to be automatically derived from video footage obtained from the area of interest and. utilized to characterize responses to the stimulus.

Preferably, the indication of response is combined with that derived from other areas of interest in order to permit the assimilation of indications relating to a plurality of said areas for comparison and evaluation.

The said area or areas of interest may comprise one or more sites within a retail establishment such as a supermarket or a department store, and/or to comparable sites in a plurality of such establishments, such as a chain of stores. Alternatively, the area or areas of interest may be locations within a transportation terminal, such as a railway station or an airport terminal for example.

Preferably, the behavior pattern includes hesitation or delay in the passage of people through or past the area of interest, consistent with attention being given to the visual stimulus. This enables the degree of interest shown in the stimulus to be derived, on-line and with readily available computing power, by means of algorithms operating

upon digitized data derived from the video images.

It is further preferred that the area of interest is defined on a floor portion abutting or otherwise adjacent the stimulus, and that the video images be derived from at least

one overhead television camera mounted directly above the floor portion. In this way, people being monitored are presented in plan view to the camera, simplifying the recognition criteria needed to enable automatic counting procedures to be implemented. Such arrangements also assist the automated sensing of motion.

An application of particular interest relates to in-store monitoring of the response of customers to visual stimuli in the form of displays of goods or products, and in such

circumstances it is preferred that an overhead camera views a floor area immediately in front of the display.

It is further preferred, in in-store applications of the invention, that the system be capable of detecting interaction of customers with the goods or products in the display, In particular, the system may detect a customer reaching out to touch or pick up the goods or products on display.

Further still, the system is preferably capable of detecting the removal of goods or product from the display. In such circumstances, it is preferred that means are provided for correlating the removal of such goods or products with the subsequent purchase thereof, as represented by a stock indicator, such as a bar code and reader, associated with a till or other point of sale device.

This correlation of the removal from the display of goods or product with subsequent purchase can provide assistance in the detection of theft, as well as a more general understanding of customer behavior.

In order to detect removal of specific goods or product from the display, particularly where the display contains goods or products of different types, brands and/or sizes, for example, the system preferably incorporates discriminator means capable of indicating the removal of goods or product from individual locations in the display.

Preferably, the discriminator means comprises a network of crossed beams of energy defined immediately adjacent or within the display. In one preferred example, the beams of energy comprise collimated infra-red beams.

Alternatively, the discriminator means may comprise means capable of recognizing a characteristic, such as shape, color or logo for example, associated with the goods or product, so that articles taken from the display and possibly also replaced therein may he automatically classified.

It will be appreciated that, when reference is made herein to visual stimuli in relation to the display of goods or products for sale, there is not necessarily anything special about the display, and it can merely comprise the normal presentation of goods or products, as on shelves, for purchase. In such circumstances, the system is capable of

providing valuable information about, for example, the location of prime in-store sites by observing (either sequentially, simultaneously or in a combination of these) customer responses to similar displays at various locations in the store.

The invention contemplates a monitoring system comprising video means sited to view an area of interest characterized by its proximity to, and/or location with respect to, at least one visual stimulus, means for generating electrical signals representing video images of said area at different times, processing means for processing said signals to determine a behavior pattern of people traversing said area and means utilizing said behavior pattern to provide an indication of a response by said people to said visual stimulus.

The system as described may be further characterized wherein the behavior pattern includes hesitation or delay in the passage of people through or past the area of interest, consistent with attention being given to the visual stimulus.

Also, the system may be characterized wherein the degree of interest shown in the stimulus is derived, on-line and with readily available computing power, by means of algorithms operating upon digitized data derived from the video images; wherein the area of interest is defined on a floor portion abutting or otherwise adjacent the stimulus; wherein the video images are derived from at least one overhead television camera mounted directly above the floor portion; wherein it is utilized for in-store monitoring of the response of customers to visual stimuli in the form of displays of goods or products; wherein it is configured to be capable of detecting interaction of customers with the goods or products in the display; wherein it is configured to detect a customer reaching out to touch, remove or replace the goods or products on display; wherein means are provided for correlating the removal of goods or products from the display with the subsequent purchase thereof, as represented by a stock indicator, such as a bar code and reader, associated with a till or other point of sale device.

In addition the system may further comprise discriminator means capable of indicating the removal of goods or product from individual locations in the display; wherein the discriminator means comprises a network of crossed beams of energy defined immediately adjacent or within the display; wherein the beams of energy comprise collimated infra-red beams.

The system according to the foregoing can be characterized wherein counting of people within the area of interest is effected by means including edge detection; wherein counting of people within the area of interest is effected by means including moving edge detection; wherein a number of people counted using said moving edge detection is subtracted from a total number of people in said area to provide an indication of a number of stationary people in said area; wherein counting of people with in the area of interest is effected by means evaluating percentage occupancy of pixels in said video image of said area of interest; wherein detection of motion of people within said area of interest is effected by blocks matching means; and/or wherein the indication of response is combined with that derived from other areas of interest in order to permit the assimilation of indications relating to a plurality of said areas for comparison and evaluation.

Other objects and advantages of the present invention will become more apparent from the ensuing detailed description.

### BRIEF DESCRIPTION OF THE DRAWINGS

In order that the invention may be clearly understood and readily carried into effect, certain embodiments thereof will now be described, by way of example only, with reference to the accompanying drawings, of which:

FIG. 1 shows, schematically and in plan view, a typical in-store layout of an area of interest in relation to a display of goods or products for sale;

FIG. 2 comprises a schematic, block-diagrammatic representation of certain components of a system, according to one example of the invention, that can be used to survey the area of interest shown in FIG. 1; and

FIG. 3 shows, in similar manner to FIG. 2, a system, in accordance with another example of the invention, linked to an in-store stock-management arrangement.

### DETAILED DESCRIPTION OF PREFERRED EMBODIMENTS OF THE INVENTION

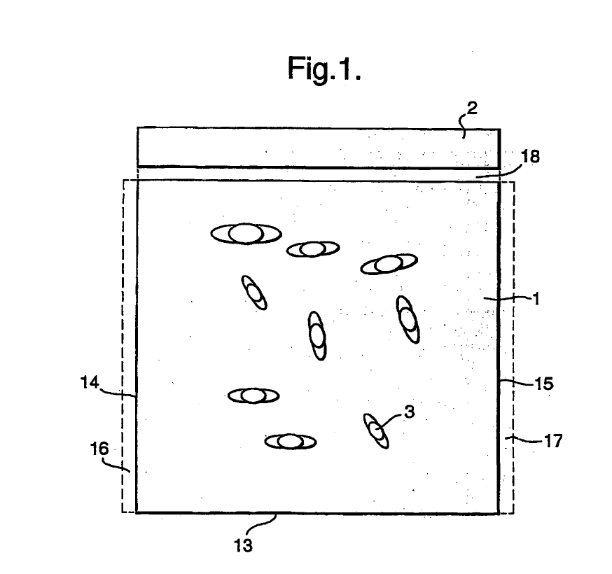

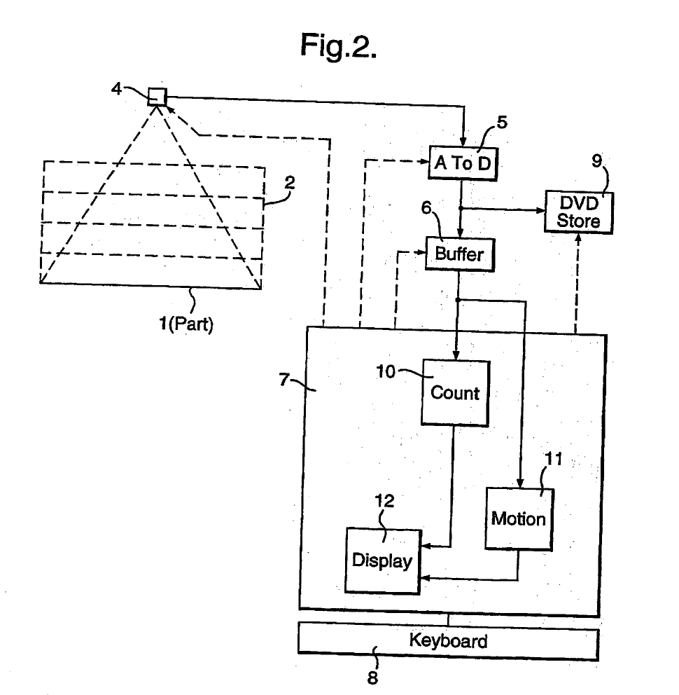

Referring now to FIG. 1, an area of interest is shown at 1; this area being substantially rectangular and notionally designated on the floor of a supermarket. The area 1 is arranged to be wholly within the view of an overhead-mounted television camera (see FIG. 2) and is positioned so that one of its edges extends parallel with, and close to, the front of a display 2 of goods or products. The display 2 may be a specially constructed display intended to draw attention to the goods or products, but in this example it comprises merely of a conventional stack of shelves, disposed one above the other and supporting the goods or products in question.

The system in accordance with this example of the invention is arranged to interpret the behavior of people 3 whilst in the area 1, and in particular a pattern of their behavior

which indicates some interest in the goods or products displayed on the shelves 2.

In this respect, the system is configured to determine the number of people in the area 1 from time to time and, either on an individual basis or collectively, an indication of movement through the area, such as a dwell time indicating length of stay in the area.

Referring now to FIG. 2 in conjunction with FIG. 1, the overhead camera is shown at 4; being positioned vertically above the area 1 and located centrally with respect thereto. This configuration is not, essential to the performance of the system, but it is preferred, as it reduces (as compared with oblique camera mountings) distortion of the images of people in the area 1 of interest, and also renders calibration of the system, in terms of allowing for the distance between the camera and the (floor) area, relatively straightforward.

The electrical signals, indicative of the image content of area 1, output from the camera 4 may be digitized at source. If not, however, they are digitized in an analogue-to digital conversion circuit 5. In either event, the digital signals are, for convenience of handling, applied to a buffer store 6, from which they ran be derived under the control of a processing computer 7. The dashed line connections shown between the computer 7 and other components in FIG. 2 indicate that the timing of signal transfers to and from, and other signal-handling operations of, those components are preferably controlled by the computer.

It will be appreciated in this general connection that, although the camera 4 will be successively generating images of the area 1, on a frame-by-frame basis, with conventional timing, not all of the images need necessarily be used by the system. For example, if (based upon the average walking pace of people in stores) it is likely that the distance that might be covered if they were to keep walking at that pace between successive frames would be too small to reliably detect, or if the use of all images would result in excessive processing effort without concomitant increase in accuracy or reliability of data, then it may be preferred to utilize the images of some frames only; the necessary adjustment or selection being made in response to operator input to the computer 7 via a keyboard 8 or any other suitable interface. The frame selection rate can, of course, be varied if it appears that the accuracy of the evaluation would be improved thereby.

If it is desired to store the entire output of camera 4, then either its direct output or the digitized data output from conversion circuit 5 can be applied as shown to a suitable store 9, such as a DVD or a video tape.

Selected frames of digitized image data are successively applied to the computer 7 which is programmed to effect, in a region thereof schematically shown at 10, a counting procedure based on any convenient technique, such as the location of edges consistent with plan aspects of people, to determine the number of people in the area 1 at the time the relevant image was taken by the camera 4.

The computer also performs, in a region thereof schematically shown at 11, and upon the same image data, a motion sensing procedure that evaluates, either for each individual in the area 1, or in a general sense, a motion criterion that indicates some behavioral characteristic of people in the area 1 representative of their response to the visual stimulus of the display 2. In this example, that behavioral characteristic is transit time through the area 1; delay or hesitation causing the normal customer transit time for the area to be exceeded (by at least a predetermined threshold period) being taken as an expression of interest in the display 2.

It will be appreciated that, in practice, the tasks notionally assigned to regions 10 and 11 of the computer 7 may be carried out, sequentially or simultaneously, in a common processor.

In any event, the data resulting from those operations are recorded and also applied to a display 12 that correlates the numerical and motion evaluations into an indication of customer response to the display 2 of goods or products.

In relation to the counting procedure assigned to region 10 of the computer 7, this can, as previously stated, be conducted on the basis of edge detection. Preferably, or in addition, however, it is conducted (or supplemented, as the case may be) on the basis of the total occupation of pixels in the image, once an image of the area 1 unoccupied has been effectively subtracted therefrom in accordance with common image processing techniques. The inventor has determined that there is a substantially linear relationship between percentage pixel occupation and the number of people in the area 1, and this can be used directly once the system has been calibrated for camera-to-floor distance.

Circle detection, using Hough Transforms, may also be used to count the heads of customers.

With regard to motion detection, as assigned to region 11 of the computer 7, if edge detection (or some other suitable technique) has been applied to locate individual people in an image, it is possible to utilize known procedures, such as block matching, to detect the speed and direction of motion of each individual. Block matching procedures involve the definition, in one frame of image data, of a patch of (say) 5×5 pixels in a region identified with a person and seeking to match the content of that patch (with greater than a specified degree of certainty) to the content of a similar patch in a subsequent frame. Displacement between the two patches, which is sought only in regions of the second image that are consistent with normal motions of people in the relevant period in order to speed up computation and reduce the computing power required, is indicative of motion of that individual during the inter-frame period.

In as alternative arrangement, motion is only studied at the edges of the area 1, to detect people entering and leaving the area. In this case, of course, there is no direct correlation with the notion of individuals, but it, is possible to derive collective or group data.

In this particular example, and referring back to FIG. 1, it is assumed that the edge 13 of the area 1 opposite the display 2 is hard against an adjacent row of shelving and thus, that people can enter the area 1 only via the edges 14 and 15 thereof. In such circumstances, notional data bars 18 and 17 are defined close to and parallel to these edges and the computer 7 is configured to evaluate, from data relating to those bars only, the flow of people into and out of the area 1. The data so evaluated are compared with the data for other locations in the store to indicate relative transit times through the area 1.

It is also possible to utilize moving edge detection procedures to determine the number of moving people in the area 1, and to thus evaluate the number of stationary people in the area by subtracting the number of moving people from the total head count carried out as described above. It is then assumed that the stationary people have an interest in the display.

As mentioned previously, information about occupancy of the area 1 and the motion characteristics of occupants can provide much useful information about the impact of a display and/or its location in the store. Other criteria can, however, be used as behavioral indicators if desired and these may be used instead of or in addition to the data about occupancy and motion to indicate customer response to the visual stimulus of the display 2.

One such other criterion is the direct interaction of customers with the goods or products in the display, as evidenced by customers reaching out to touch the goods or products and whether they actually remove them from the display or return them to the display.

Reaching movements and their direction can be detected by applying the techniques outlined above to a gap area 18 notionally defined between the area 1 and the display 2; the gap area 18 being parallel to the edge 13 and viewed by the camera 4. Image data relating to the gap area 18 is processed in computer 7 to detect and reveal reaching movements, withdrawal of goods or products from the display 2 and possibly also their replacement therein.

With certain goods and products, for example items of uniform and readily distinguishable coloring, it is possible for the computer evaluation to determine the precise nature of an item removed from the display (or to replaced therein) without further assistance. In other circumstances, however, further information is required, such as the region of the display from which the item was removed (or into which it was replaced) in order that the item can be reliably identified. Such information can be derived in a number of ways, for example by means of weight sensors of the shelves of the display 2. A preferred technique, however, utilizes a network of crossing energy beams, for example infra-red beams, configured to provide information as to the spatial position within the display from which an item has been withdrawn (or into which it has been replaced) by a customer.

Techniques utilizing infra-red beams, or other beams, to provide spatial information are well known, and axe used for example in the field of hotel minibars to remotely determine consumption of product and hence the need for replacement.

Such spatial information can be used merely to supplement occupancy and movement data to provide higher degrees of sophistication in the presentation of data on the output display 12, but it can also (ox alternatively) be used in a wider context linking items withdrawn from the display 2, and not replaced therein, to their subsequent purchase at a point of sale.

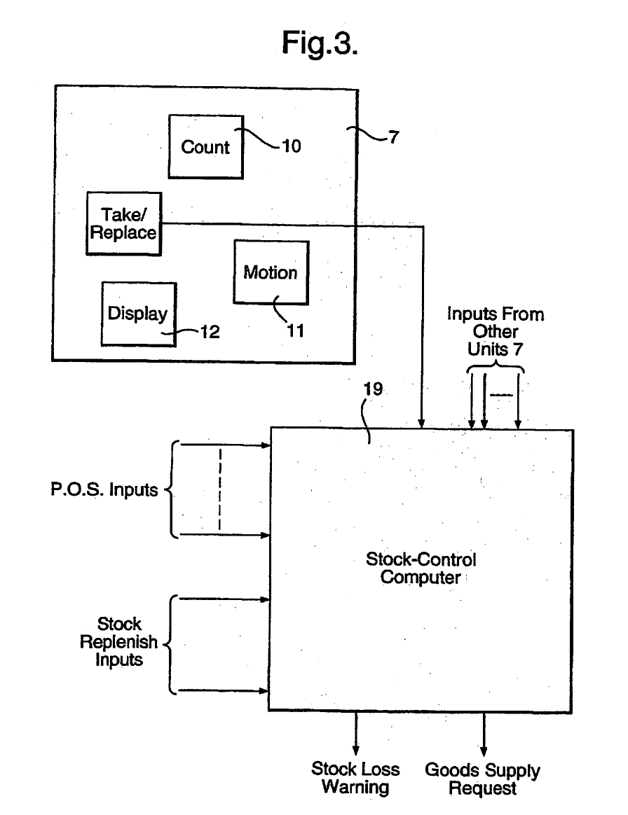

Referring now to FIG. 3, information derived from the computer 7, and concerning withdrawal by customers of items from display 2, is fed to a central computer 19 that comprises, or is linked to, the main stock-control system of the store. Usually, the stock-control system will be based upon the scanning of product-specific bar codes at points of sale in the store. In such circumstances, if an item is withdrawn from the display 2 by a customer who does not replace it, there is an expectation that, within a certain to time window consistent with normal progress of customers through the store, the appropriate bar code will be scanned in at a point of sale. If that does not occur, there is a possibility that the item has been stolen (though it may of course have been put back somewhere else in the store).

Whilst, in accordance with the system described thug far, there is no recoverable data that could link an individual with a specific item removed and not paid for, repeated occurrences in relation to specific items and/or from specific locations would indicate to the store manager that increased security at those points would be appropriate.

As mentioned previously, significant potential value attaches to the correlation of information derived from the monitoring of several sites within one store and/or within several stores. By this means, useful “global” information about the comparative values of sites and/or stores for the promotion and sale of certain products may be obtained.

In order to achieve this, the processing computers handling the data for individual sites are linked to a central computer (for a store or for several stores) as a local computer network. The information from individual processing computers is sent to the central computer, where it is integrated by suitable algorithms into an information set indicative of “global” customer information representative of behavior patterns, in relation to the stimulus or stimuli under investigation, over an entire store, or chains of stores. By linking the central computer with stock control computers, information about distributions of product and their likely selling rates can be derived.

Whereas the invention has been shown and described in terms of preferred embodiments, nevertheless changes and modifications are possible that do not depart from the teachings herein. Such changes and modifications are deemed to fall within the purview of the invention.

What is claimed is:

1. A monitoring system comprising video means sited to view an area of interest characterized by its proximity to, and/or location with respect to, at least one visual stimulus, means for generating electrical signals representing video images of said area at different times, processing means for processing said signals to determine a behavior pattern of people traversing said area and means utilizing said behavior pattern to provide an indication of a response by said people to said visual stimulus.

2. A system according to claim 1 wherein the behavior pattern includes hesitation or delay in the passage of people through or past the area of interest, consistent with attention being given to the visual stimulus.

3. A system according to claim 2 wherein the degree of interest shown in the stimulus is derived, on-line and with readily available computing power, by means of algorithms operating upon digitized data derived from the video images.

4. A system according to claim 1 wherein the area of interest is defined on a floor portion abutting or otherwise adjacent the stimulus.

5. A system according to claim 1 wherein the video images are derived from at least one overhead television camera mounted directly above the floor portion.

6. A system according claim 1 utilized for in-store monitoring of the response of customers to visual stimuli in the form of displays of goods or products.

7. A system according to claim 6 configured to be capable of detecting interaction of customers with the goods or products in the display.

8. A system according to claim 7 configured to detect a customer reaching out to touch, remove or replace the goods or products on display.

9. A system according to claim 8 wherein means are provided for correlating the removal of goods or products from the display with the subsequent purchase thereof, as represented by a stock indicator, such as a bar code and reader, associated with a till or other point of sale device.

10. A system according to claim 9 further comprising discriminator means capable of indicating the removal of goods or product from individual locations in the display.

11. A system according to claim 10 wherein the discriminator means comprises a network of crossed beams of energy defined immediately adjacent or within the display.

12. A system according to claim 11 wherein the beams of energy comprise collimated infra-red beams.

13. A system according to claim 1 wherein counting of people within the area of interest is effected by means including edge detection.

14. A system according to claim 1 wherein counting of people within the area of interest is effected by means including moving edge detection.

15. A system according to claim 14 wherein a number of people counted using said moving edge detection is subtracted from a total number of people in said area to provide an indication of a number of stationary people in said area.

16. A system according to claim 1 wherein counting of people with in the area of interest is effected by means evaluating percentage occupancy of pixels in said video image of said area of interest.

17. A system according to claim 1 wherein detection of motion of people within said area of interest is effected by blocks matching means.

18. A system according to claim 1 wherein the indication of response is combined with that derived from other areas of interest in order to permit the assimilation of indications relating to a plurality of said areas for comparison and evaluation.
